(19) United States
(12) Patent Application Publication
(10) Pub. No.: US 2016/0165709 A1
(43) Pub. Date: Jun. 9, 2016

(54) System and Method for Isolating Gain Elements in a Laser System

(71) Applicant: ASML Netherlands B.V., Veldhoven (NL)

(72) Inventors: Yezheng Tao, San Diego, CA (US); Daniel John William Brown, San Diego, CA (US); Daniel J. Golich, San Diego, CA (US); Michael Kats, San Diego, CA (US); John T. Stewart, Escondido, CA (US); Rostislav Rokitski, San Diego, CA (US)

(21) Appl. No.: 14/562,237

(22) Filed: Dec. 5, 2014

(51) Int. Cl. H05G 2/00

(52) U.S. Cl. CPC H05G 2/008; H05G 2/003

(57) ABSTRACT

A method and apparatus for protecting the seed laser a laser produced plasma (LPP) extreme ultraviolet (EUV) light system are disclosed. An isolation stage positioned on an optical path diverts light reflected from further components in the LPP EUV light system from reaching the seed laser. The isolation stage comprises two AOMs that are separated by a delay line. The AOMs, when open, direct light onto the optical path and, when closed, direct light away from the optical path. The delay introduced by the delay line is determined so that the opening and the closing of the AOMs can be timed to direct a forward-moving pulse onto the optical path and to divert reflected light at other times. The isolation stage can be positioned between gain elements to prevent amplified reflected light from reaching the seed laser and other potentially harmful effects.

### FIELD OF THE INVENTION

The present application relates generally to laser produced plasma (LPP) extreme ultraviolet (EUV) light sources and, more specifically, to a method and system to prevent feedback through gain elements within such light sources.

### BACKGROUND

The semiconductor industry continues to develop lithographic technologies which are able to print ever-smaller integrated circuit dimensions. Extreme ultraviolet (“EUV”) light (also sometimes referred to as soft x-rays) is generally defined to be electromagnetic radiation having wavelengths of between 6 and 50 nanometers (nm). EUV lithography is currently generally considered to include EUV light at wavelengths in the range of 5-7 nm, and is used to produce extremely small features, for example, sub-10 nm features, in substrates such as silicon wafers. To be commercially useful, it is desirable that these systems be highly reliable and provide cost effective throughput and reasonable process latitude.

Methods to produce EUV light include, but are not necessarily limited to, converting a material into a plasma state that has one or more elements, e.g., xenon, lithium, tin, indium, antimony, tellurium, aluminum, etc., with one or more emission line(s) in the EUV range. In one such method, often termed laser produced plasma (“LPP”), the required plasma can be produced by irradiating a target material, such as a droplet, stream or cluster of material having the desired line-emitting element, with a laser beam at an irradiation site. The line-emitting element may be in pure form or alloy form, for example, an alloy at is a liquid at desired temperatures, or may be mixed or dispersed with another material such as a liquid.

In some prior art LPP systems, droplets in a droplet stream are irradiated by a separate laser pulse to form a plasma from each droplet. Alternatively, some prior art systems have been disclosed in which each droplet is sequentially illuminated by more than one light pulse. In some cases, each droplet may be exposed to a so-called “pre-pulse” to heat, expand, gasify, vaporize, and/or ionize the target material and/or generate a weak plasma, followed by a so-called “main pulse” to generate a strong plasma and convert most or all of the pre-pulse affected material into plasma and thereby produce an EUV light emission. It will be appreciated that more than one pre-pulse may be used and more than one main pulse may be used, and that the functions of the pre-pulse and main pulse may overlap to some extent.

Since EUV output power in an LPP system generally scales with the drive laser power that irradiates the target material, in some cases it may also be considered desirable to employ an arrangement including a relatively low-power oscillator, or “seed laser,” and one or more amplifiers to amplify the pulses from the seed laser. The use of a large amplifier allows for the use of the seed laser while still providing the relatively high power pulses used in the LPP process.

However, the irradiation of the droplets by the laser pulses may result in reflections and thus light propagating back toward the seed laser, through the gain elements. This can cause undesired modulation of the forward laser pulses, as well as gain stripping in pre-amplifiers. Further, the seed laser may include sensitive optics, and, since the pulses from the seed laser have been amplified, this back-propagating light may be of a large enough intensity to damage the relatively fragile seed laser.

For example, in some cases the amplifier(s) may have a signal gain on the order of 100,000 (i.e., 10⁵). In such a case, a typical protection device of the prior art, such as a polarization discriminating optical isolator, which may for example stop approximately 93 to 99 percent of the back-propagating light, may be insufficient to protect the seed laser from damage.

Accordingly, it is desirable to have an improved system and method for isolating gain elements and protecting the seed laser in such an EUV light source.

### SUMMARY OF THE INVENTION

As described herein, AOMs are used to provide isolation between a series of pre-amplifiers by adding a time delay between a pair of AOMs.

According to some embodiments, a system comprises: a laser seed module for producing laser light on an optical path; a first gain element positioned along the optical path; a second gain element positioned along the optical path after the first gain element; and an isolation stage positioned along the optical path between the first gain element and the second gain element, the isolation stage configured to divert light reflected back along the optical path from the second gain element, the isolation stage comprising: a first acoustic-optical modulator (AOM) configured to transition over a first period of time between a first state in which light is directed along the optical path and a second state in which light is not directed along the optical path; a second AOM configured to transition over a period of time between a first in which light is directed along the optical path and a second state in which light is not directed along the optical path, the transitioning of the second AOM occurring after a time delay; and a delay device positioned between the first AOM and the second AOM and configured to delay the transmission of the laser beam between the first AOM and the second AOM for a time selected based on the period of time to transition between both of the first states and both of the second states and a pre-determined period of time during which the first AOM and the second AOM both remain in the first state.

According to some embodiments, a method comprises: producing laser light on an optical path; passing a laser pulse generated from the laser light through a first gain element positioned along the optical path; passing the laser pulse through an isolation stage positioned along the optical path between the first gain element and a second gain element, the isolation stage configured to divert light reflected back along the optical path from the second gain element, the isolation stage comprising: a first acoustic-optical modulator (AOM) configured to transition over a period of time between a first state in which light is directed along the optical path and a second state in which light is not directed along the optical path; a second AOM configured to transition over the period of time between the first state in which light is directed along the optical path and a second state in which light is not directed along the optical path, the transition occurring after a time delay; and a delay device positioned between the first AOM and the second AOM and configured to delay the transmission of a laser beam between the first AOM and a second AOM for a time selected based on the period of time to transition between both of the first states and both of the second states and a period of time during which the first AOM and the second AOM both remain in the first state; and passing the laser pulse through a second gain element positioned along the optical path after the first gain element.

### BRIEF DESCRIPTION OF THE DRAWINGS

FIG. 1 is an illustration of some of the components of one embodiment of an LPP EUV system.

FIG. 2 an illustration of some of the components of one embodiment of a seed laser module that may be used in an EUV system.

FIG. 3 is a simplified block diagram of one embodiment of a pulse generation system using a seed laser module.

FIGS. 4A to 4E are simplified block diagrams of one embodiment of an acoustic-optical modulator.

FIGS. 5A to 5B are simplified block diagrams of one embodiment of an isolation stage.

FIG. 6 is a simplified timing diagram depicting how light is diverted by the isolation stage in one embodiment.

FIG. 7 is a flowchart of one embodiment of a method of diverting reflected light.

### DETAILED DESCRIPTION

In LPP EUV generation systems, a seed laser typically generates a seed pulse that is shaped, amplified, and otherwise modified by various elements before irradiating a target material. The seed laser may be fragile, and light may be reflected from the target material and back to the seed laser. Along the reverse path, the reflected light may be added to, amplified, and modified by the same elements that modified the seed pulse. Acousto-optic modulators (AOMs) are thus commonly used as switches to divert or pass light traveling in both directions.

One challenge when using AOMs is that Bragg AOMs require a period of time (e.g., one microsecond) to transition from an open state (deflecting light along an optical path) to a closed state (diverting light from the optical path). This time can be significantly longer than the length of the seed pulse, during which reflected light can pass through the AOM, potentially damaging the other elements.

To protect the seed laser as well as other elements in the LPP EUV system, an isolation stage is positioned between certain elements. The isolation stage comprises a delay line positioned between two AOMs. The AOMs are timed such that each allows a forward propagating pulse generated by the seed laser to pass along the optical path and to divert reflected light from the optical path at other times. When the first AOM deflects the pulse onto the optical path, the second diverts reflected light, and vice-versa. The delay line is used to delay light that has passed through one of the AOMs while the other AOM transitions to a desired state.

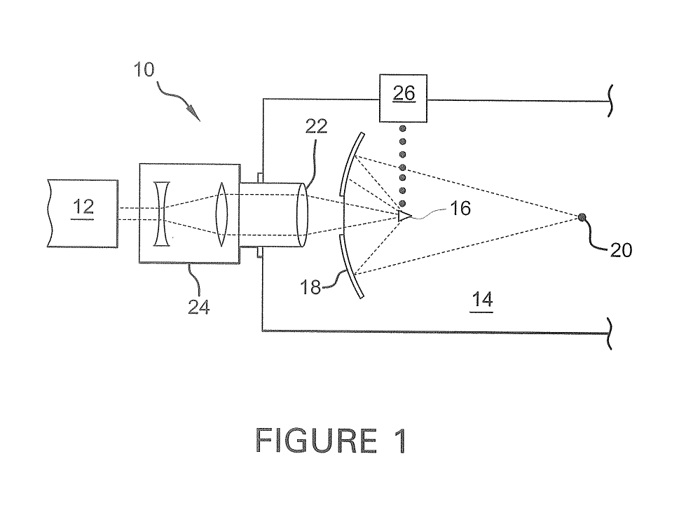

FIG. 1 is a simplified schematic view of some of the components of one embodiment of an LPP EUV light source 10. As shown in FIG. 1, the EUV light source 10 includes a laser source 12 for generating a beam of laser pulses and delivering the beam along one or more optical paths from the laser source 12 and into a chamber 14 to illuminate a respective target, such as a droplet, at an irradiation region 16. Examples of laser arrangements that may be suitable for use as laser source 12 in the EUV light source 10 shown in FIG. 1 are described in more detail below.

As also shown in FIG. 1, the EUV light source 10 may also include a target material delivery system 26 that, for example, delivers droplets of a target material into the interior of chamber 14 to the irradiation region 16, where the droplets will interact with one or more laser pulses to ultimately produce plasma and generate an EUV emission. Various target material delivery systems have been presented in the prior art, and their relative advantages will be apparent to those of skill in the art.

As above, the target material is an EUV emitting element that may include, but is not necessarily limited to, a material that includes tin, lithium, xenon or combinations thereof. The target material may be in the form of liquid droplets, or alternatively may be solid particles contained within liquid droplets. For example, the element tin may be presented as a target material as pure tin, as a tin compound, such as SnBr₄, SnBr₂, SnH₄ as a tin alloy, e.g., tin-gallium alloys, tin-indium alloys, or tin-indium-gallium alloys, or a combination thereof. Depending on the material used, the target material may be presented to the irradiation region 16 at various temperatures including room temperature or near room temperature (e.g., tin alloys or SnBr₄), at a temperature above room temperature (e.g., pure tin), or at temperatures below room temperature (e.g., SnH₄). In some cases, these compounds may be relatively volatile, such as SnBr₄. Similar alloys and compounds of EUV emitting elements other than tin, and the relative advantages of such materials and those described above will be apparent to those of skill in the art.

Returning to FIG. 1, the EUV light source 10 may also include an optical element 18 such as a near-normal incidence collector mirror having a reflective surface in the form of a prolate spheroid (i.e., an ellipse rotated about its major axis), such that the optical element 18 has a first focus within or near the irradiation region 16 and a second focus at a so-called intermediate region 20, where the EUV light may be output from the EUV light source 10 and input to a device utilizing EUV light such as an integrated circuit lithography tool (not shown). As shown in FIG. 1, the optical element 18 is formed with an aperture to allow the laser light pulses generated by the laser source 12 to pass through and reach the irradiation region 16.

The optical element 18 should have an appropriate surface for collecting the EUV light and directing it to the intermediate region 20 for subsequent delivery to the device utilizing the EUV light. For example, optical element 18 might have a graded multi-layer coating with alternating layers of molybdenum and silicon, and in some cases, one or more high temperature diffusion barrier layers, smoothing layers, capping layers and/or etch stop layers.

It will be appreciated by those of skill in the art that optical elements other than a prolate spheroid mirror may be used as optical element 18. For example, optical element 18 may alternatively be a parabola rotated about its major axis or may be configured to deliver a beam having a ring-shaped cross section to an intermediate location. In other embodiments, optical element 18 may utilize coatings and layers other than or in addition to those described herein. Those of skill in the art will be able to select an appropriate shape and composition for optical element 18 in particular situation.

As shown in FIG. 1, the EUV light source 10 may include a focusing unit 22 which includes one or more optical elements for focusing the laser beam to a focal spot at the irradiation site. EUV light source 10 may also include a beam conditioning unit 24, having one or more optical elements, between the laser source 12 and the focusing unit 22, for expanding, steering and/or shaping the laser beam, and/or shaping the laser pulses. Various focusing units and beam conditioning units are known in the art, and may be appropriately selected by those of skill in the art.

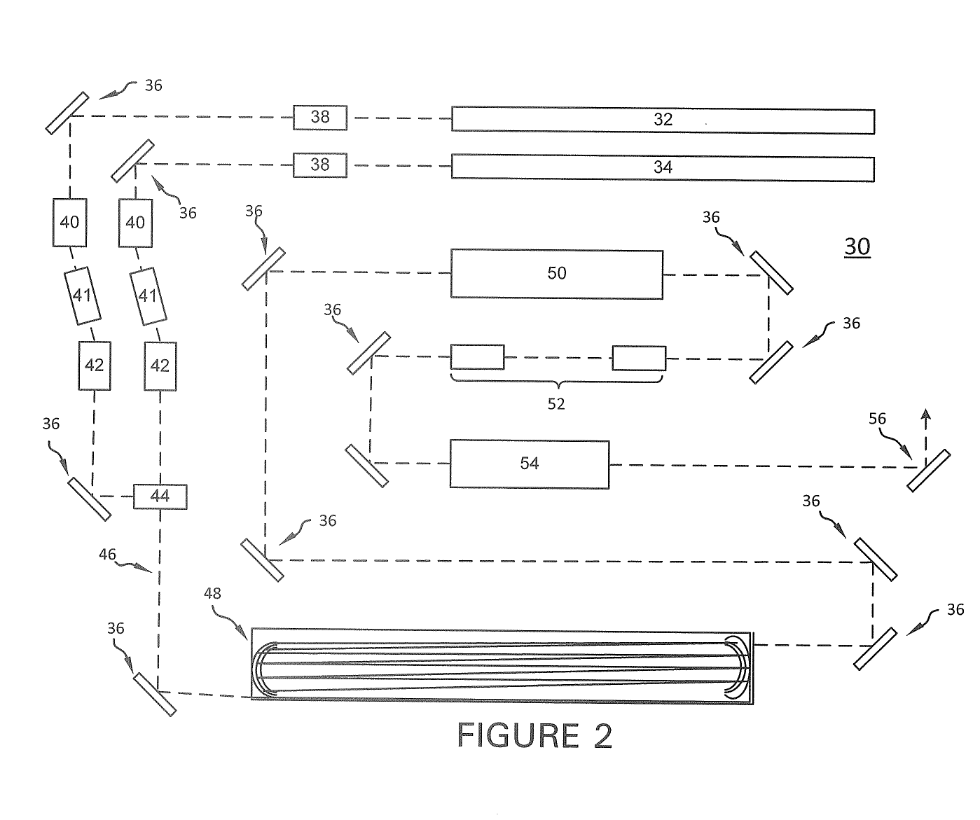

As noted above, in some cases an LPP EUV system uses one or more seed lasers to generate laser pulses, which may then be amplified to become the laser beam that irradiates the target material at irradiation site 16 to form a plasma that produces the EUV emission. FIG. 2 is a simplified schematic view of one embodiment of a seed laser module 30 that may be used as part of the laser light source in an LPP EUV system.

As illustrated in FIG. 2, seed laser module 30 includes two seed lasers, a pre-pulse seed laser 32 and a main pulse seed laser 34. One of skill in the art will appreciate that where such an embodiment containing two seed lasers is used, the target material may be irradiated first by one or more pulses from the pre-pulse seed laser 32 and then by one or more pulses from the main pulse seed laser 34.

Seed laser module 30 is shown as having a “folded” arrangement rather than arranging the components in a straight line. In practice, such an arrangement is typical in order to limit the size of the module. To achieve this, the beams produced by the laser pulses of pre-pulse seed laser 32 and main pulse seed laser 34 are directed onto desired optical paths by a plurality of optical components 36. Depending upon the particular configuration desired, optical components 36 may be such elements as lenses, filters, prisms, mirrors or any other element which may be used to direct the beam in a desired direction. In some cases, optical components 36 may perform other functions as well, such as altering the polarization of the passing beam.

In the embodiment of FIG. 2, the beams from each seed laser are first passed through electro-optic modulators 38 (EOMs). The EOMs 38 are used with the seed lasers as pulse shaping units to trim the pulses generated by the seed lasers to pulses having shorter duration and faster fall-time. A shorter pulse duration and relatively fast fall-time may increase EUV output and light source efficiency because of a short interaction time between the pulse and a target, and because unneeded portions of the pulse do not deplete amplifier gain. While two separate pulse shaping units (EOMs 38) are shown, alternatively a common pulse shaping unit may be used to trim both pre-pulse and main pulse seeds.

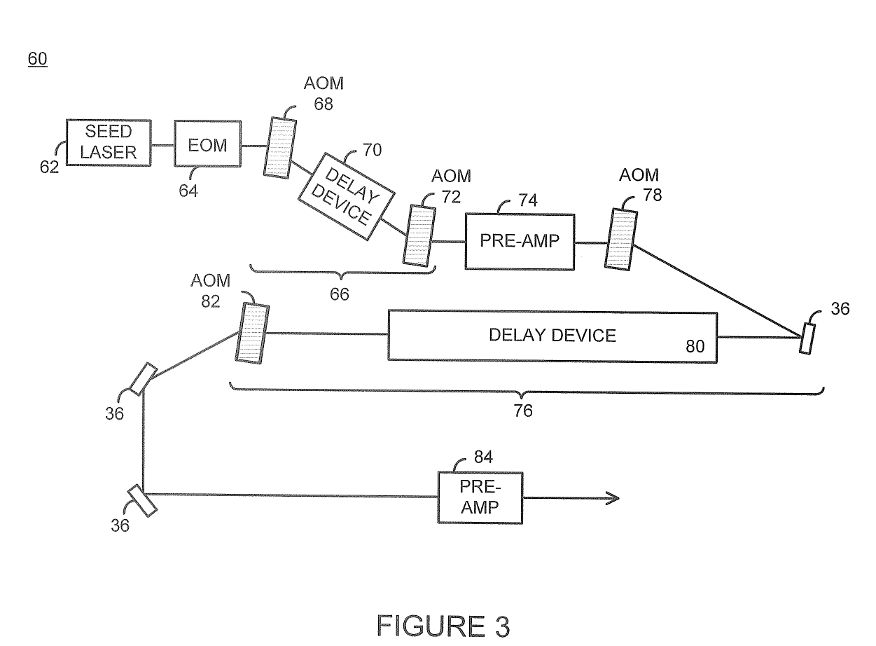

The beams from the seed lasers are then passed through an isolation stage comprising acousto-optic modulators (AOMs) 40 and 42 and beam delay devices 41. As will be explained below, the AOMs 40 and 42 act as “switches” or “shutters,” which operate to divert any reflections of the laser pulses from the target material from reaching the seed lasers; as above, seed lasers typically contain sensitive optics, and the AOMs 40 and 42 thus prevent any reflections from causing damage to the seed laser elements. The delay devices 41 are such as is known in the art; as more clearly seen in delay device 48, delay devices 41 have a beam folding optical arrangement including optical components such as mirrors, prisms, etc., such that light passing through the unit travels an optical delay distance, d_{delay}; using an estimated light speed of about 3×10⁸ meters per second, each meter of beam delay adds an additional approximately 3.33 ns of travel time for the light on the optical path. Additional details about the delay devices 41 and the isolation stage are discussed in greater detail below, particularly in connection with a first isolation stage 33 of FIG. 3. In the embodiment shown here, the beams from each seed laser pass through two AOMs. Further, as will be discussed elsewhere herein, the isolation stage may be positioned elsewhere in the seed laser module 30.

After passing through the AOMs 42, the two beams are “combined” by beam combiner 44. Since the pulses from each seed laser are generated at different times, this really means that the two temporally separated beams are placed on a common optical path 46 for further processing and use.

After being placed on the common optical path, the beam from one of the seed lasers (again, there will only be one at a time) passes through another beam delay device 48 having a beam folding optical arrangement. Next, the beam is directed through at least one pre-amplifier 50 and then through a beam expander 52. Following this, the beam passes through a thin film polarizer 54, and is then directed onward by optical component 56, which again is an element which directs the beam to the next stage in the LPP EUV system and may perform other functions as well. From optical component 56, the beam typically passes to one or more optical amplifiers and other components, as will be illustrated below.

Various wavelength tunable seed lasers that are suitable for use as both pre-pulse and main pulse seed lasers are known in the art. For example, in one embodiment a seed laser may be a CO₂ laser having a sealed filling gas including CO₂ at sub-atmospheric pressure, for example, 0.05 to 0.2 atmospheres, and pumped by a radio-frequency discharge. In some embodiments, a grating may be used to help define the optical cavity of the seed laser, and the grating may be rotated to tune the seed laser to a selected rotational line.

FIG. 3 is a simplified block diagram of one embodiment of a seed pulse generation system 60. Like the seed laser module 30, the seed pulse generation system 60 generates seed pulses, shapes the seed pulses, and amplifies the seed pulses. However, the seed pulse generation system 60 includes two pre-amplifiers 74 and 84 instead of the one pre-amplifier 50 of seed laser module 30 of FIG. 2. The addition of a second pre-amplifier, and the additional gain provided by the second pre-amplifier, can result in a higher likelihood that power amplifiers positioned beyond the seed pulse generation system 60 will self-lase, inducing modulation of forward laser pulses and gain-stripping the pre-amplifiers 74 and 84 in the seed pulse generation system 60. The resulting self lasing in the power amplifiers has been observed as a pulse having a broad duration lasting several microseconds. To attenuate these effects of adding the second pre-amplifier, the seed pulse generation system 60 of FIG. 3 includes additional isolation stages positioned between the elements of the seed laser module 30 of FIG. 2 to prevent reflected light from reaching a seed laser as well as a second pre-amplifier. The isolation stages of the seed pulse generation system 60 can be added to, or implemented within, the seed laser module 30 of FIG. 2, as will be apparent to those skilled in the art.

In FIG. 3, although the seed laser 62 is depicted as a single unit, it produces a beam as described in connection with the pre-pulse seed laser 32 and the main pulse seed laser 34 of FIG. 2. Again as will be understood by those skilled in the art, the seed pulse generation system 60 may include more than one seed laser 62. The EOM 64 shapes the pulses as described in connection with the EOM 38 of FIG. 2 above.

A first isolation stage 66 is positioned between the EOM 64 and the first pre-amplifier 74. The first isolation stage 66 comprises a first AOM 68, a delay device 70, and a second AOM 72; the delay device 70 again has a beam folding optical arrangement. The first isolation stage 66, like the AOMs 40 and 42 and the delay line 41 of FIG. 2, operates to divert any reflections of the laser pulses from the target material from reaching the seed laser 62. As detailed further herein, the isolation stage 66 provides improved isolation from amplified pulses that have passed through a first pre-amplifier 74.

To amplify the seed pulses generated by the seed laser 62, the seed pulses are passed through two or more pre-amplifiers, rather than just one pre amplifier, as shown in FIG. 2. By using more than one pre-amplifier, the seed pulses can be amplified in stages, which has a number of benefits. The use of separate amplifiers having smaller individual gains prevents self-lasing of the optical elements. Another benefit following from the use of isolation stages with multiple pre-amplifiers is that reflected light can be diverted mid-amplification, before the gain is so high that even 1% of the reflected light is still powerful enough to damage the seed laser 62 after 99% of the reflected light is diverted.

The first pre-amplifier 74 is followed by a second isolation stage 76 which comprises a first AOM 78, a delay device 80, and a second AOM 82. The second isolation stage 76 is able to divert reflected light originating in other parts of the LPP EUV system than the first isolation stage. Since the second pre-amplifier 84 follows the second isolation stage 76 for a pulse traveling to the irradiation site, all of the reflected light that reaches the second isolation stage 76 will have also been amplified by the second pre-amplifier 84.

While not depicted, a further isolation stage may follow the second pre-amplifier 84 before the beam is directed to still further elements of the LPP EUV generation system. Such a further isolation stage can divert reflected light arriving from further components in the LPP EUV system before the reflected light is amplified by the second pre-amplifier 84.

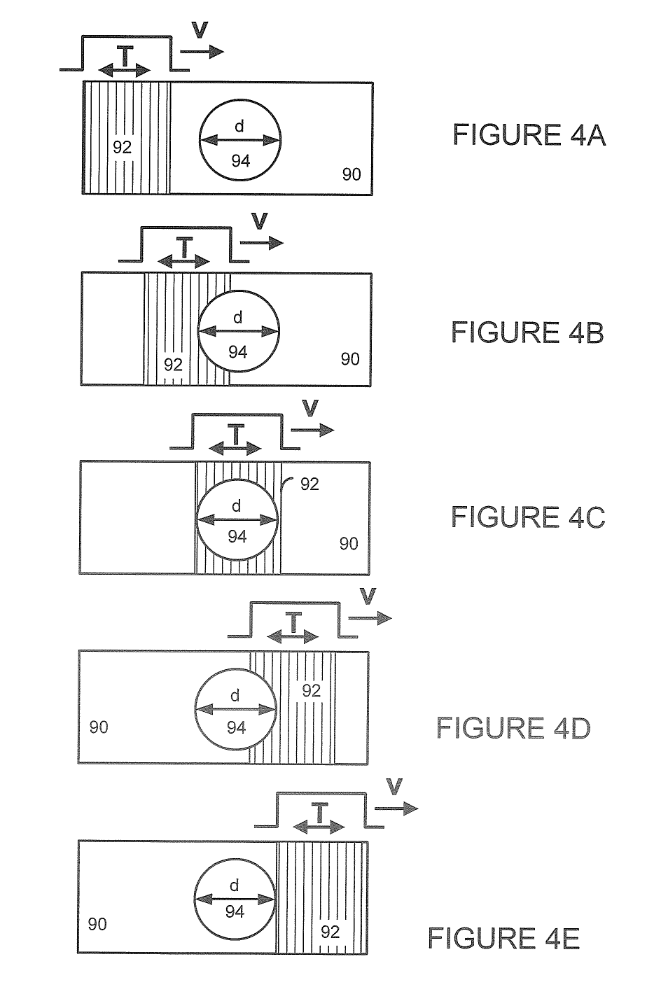

FIGS. 4A to 4E are simplified block diagrams of one embodiment of an AOM 90, such as those depicted in the seed pulse generation systems 30 of FIGS. 2 and 60 of FIG. 3. AOM 90 may be a Bragg AOM, with which those skilled in the art will be familiar and is depicted at five points in time during its operation. As described above with respect to AOMs 40 and 42 of FIG. 2, AOM 90 acts as “switch” or a “shutter” to deflect or divert light, depending on its present state. AOM 90 uses the acousto-optic effect, in which an acoustic (sound) wave within a material causes a change in the optical characteristics of the material, to diffract and shift the frequency of light passing through the AOM 90.

As is known in the art, AOM 90 is typically activated by a piezoelectric transducer (PZT) attached to one end of the AOM. Power (typically radio frequency (RF) power) is applied to the PZT as an oscillating electric signal, which causes the PZT to vibrate and creates an acoustic wave 92 in the AOM. When no power is applied, there is thus no acoustic wave 92, and light is transmitted directly through the AOM; when power is applied, the acoustic wave is present and the AOM operates in a “deflection mode” in which the incident light beam is deflected onto the beam path and shifted in frequency. An amplitude of the RF power applied to the PZT in the deflection mode is sufficient to deflect the light onto the beam path. As is apparent to those skilled in the art, the amplitude need only direct the light by a sufficient degree to effectuate the deflection. Due to the desired switching speeds, power is typically applied to the PZT at the direction of a processor or controller.

As depicted in the FIGS. 4A to 4E, the acoustic wave 92 travels across the AOM 90. The acoustic wave 92 has a known length based on a period of time T during which power is applied to the PZT, as well as a velocity V. The AOM 90 is positioned on the optical path so as to intercept the pulses at a beam aperture 94. The beam aperture 94 is depicted in the figure as a circle having a diameter “d” but is not necessarily a physical feature of the AOM 90. The amount of time T, during which the acoustic wave 92 overlaps the beam aperture 94 (referred to as the minimum acoustic packet size) to allow a pulse to pass, may be calculated from the beam diameter and pulse duration by the equation:

T=D/V+dT

where D is the beam diameter, V as above is the velocity at which the acoustic wave propagates through the AOM 90 (constant for the AOM), and dT is the optical pulse duration (also constant for the AOM). When the beam diameter is 4 millimeters, the velocity of the acoustic packet is 5500 meters per second, and the optical pulse duration is 200 nanoseconds, the resulting minimum acoustic packet size is 927 nanoseconds.

Once initiated as shown in FIG. 4A, the acoustic wave 90 propagates across AOM 90 in one direction. When the acoustic wave 90 overlaps the beam aperture 94 of the AOM 90 (as shown in FIG. 4C), the beam is deflected onto the optical path so as to continue to other elements. When the acoustic wave 92 does not overlap with the beam aperture 94, light coming from either direction in the seed generation system 60 is passed so as to not follow the optical path. As such, when no acoustic wave is present at the beam aperture 94, reflected light is less likely to reach the seed laser 32, as shown in FIGS. 4A and 4E.

When the acoustic wave 92 partially overlaps the beam aperture 94 as shown in FIGS. 4B and 4D, a portion of light hitting the portion having the acoustic wave 92 is deflected on to the optical path while the remainder passes through the AOM 90. Thus, a portion of the reflected light traveling from the chamber towards the seed pulse generator may pass through the portion where the acoustic wave 92 overlaps the beam aperture 94 and be directed onto the optical path. A remaining portion of the reflected light is prevented from following the optical path where no acoustic wave is present. In some instances, the deflected portion of the beam exhibits a phenomenon known as “beam imaging” where the deflected portion retains the shape of the portion of the beam as it is deflected. Beam imaging is observed as a shifting of the beam from the center of the beam aperture 94 and may have a non-circular, ovoid, or semi-circular shape.

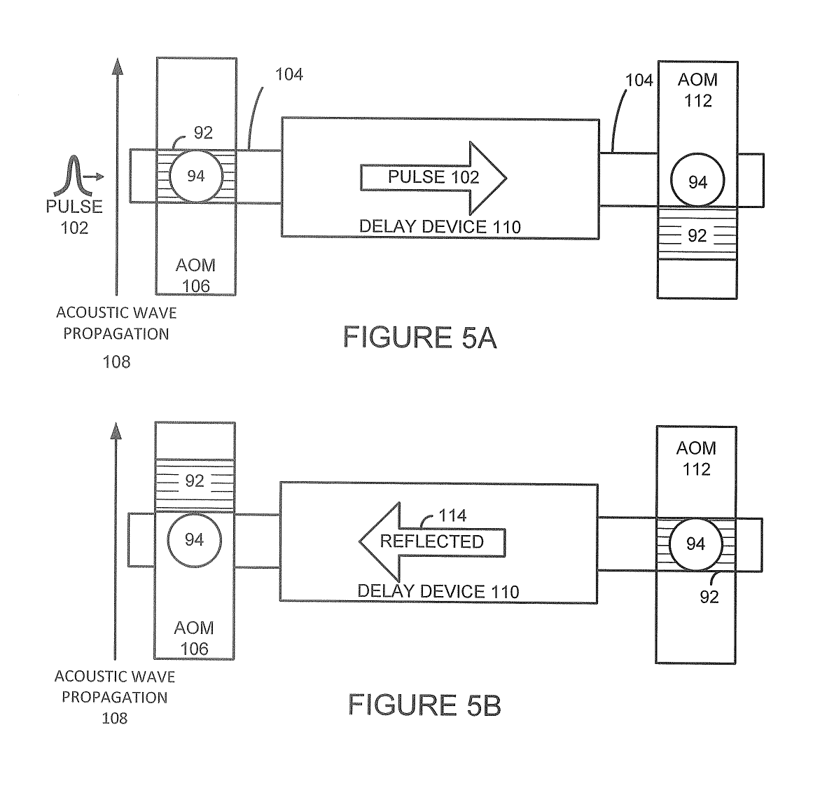

FIGS. 5A and 5B are simplified block diagrams of one embodiment of an isolation stage, such as isolation stages 66 and 76. In FIG. 5 the isolation state is shown as being comprised of AOMs 106 and 112, and delay device 110. FIG. 5A and FIG. 5B together depict relative states of the AOMs as a seed pulse and reflected light, respectively, pass through the isolation stage. As described above, when an acoustic wave 92 overlaps a beam aperture 94, light is deflected onto an optical path depicted as optical path 104. When the acoustic wave 92 does not overlap the beam aperture 94, light is directed away from the optical path 104. As is known in the art, the light passes through the AOM when the acoustic wave 92 is not present, however, for simplicity, FIG. 5 depicts the optical path 104 as a straight line.

As seen in FIG. 5A, in operation a pulse 102, generated by the seed laser 62, reaches the first AOM 106 as an acoustic wave 92 propagating across the AOM 106 in direction 108 reaches the beam aperture 94. The pulse 102 passes along the optical path 104 to a delay device 110. When the pulse 102 passes through the AOM 106, a second AOM 112 positioned immediately after the delay device 110 is in a state such that it prevents reflected light originating from beyond the isolation stage from entering the delay device 110 and proceeding back to the seed laser 62.

While the pulse 102 travels through the delay device 110, acoustic waves 92 in the first AOM 106 and the second AOM 112 continue to propagate. In the second AOM 112, the acoustic wave 92 is generated after the acoustic wave 92 is generated in the first AOM 106, such that it is delayed by a predetermined amount of time. The delay between when the acoustic waves are generated and the amount of delay introduced into the optical path by the delay device 110 are coordinated so that when the pulse 102 reaches the second AOM 112 the acoustic wave 92 is at the beam aperture 94 and is deflected so as to continue further along the optical path 104.

While the second AOM 112 is deflecting the pulse 102 onto the optical path 104, the first AOM 106 is in the opposite state that prevents light from following the optical path 104. Thus, as seen in FIG. 5B, if any reflected light 114 passes through the second AOM 112 while it is partially or fully directing the forward pulse onto the optical path 104, the reflected light 114 continues through the delay device 110 while the acoustic wave 92 in the first AOM 106 propagates out of the beam aperture 94. After the acoustic wave 92 is out of the beam aperture 94 on the first AOM 106, the reflected light 114 is prevented from continuing back to the seed laser on the optical path 104.

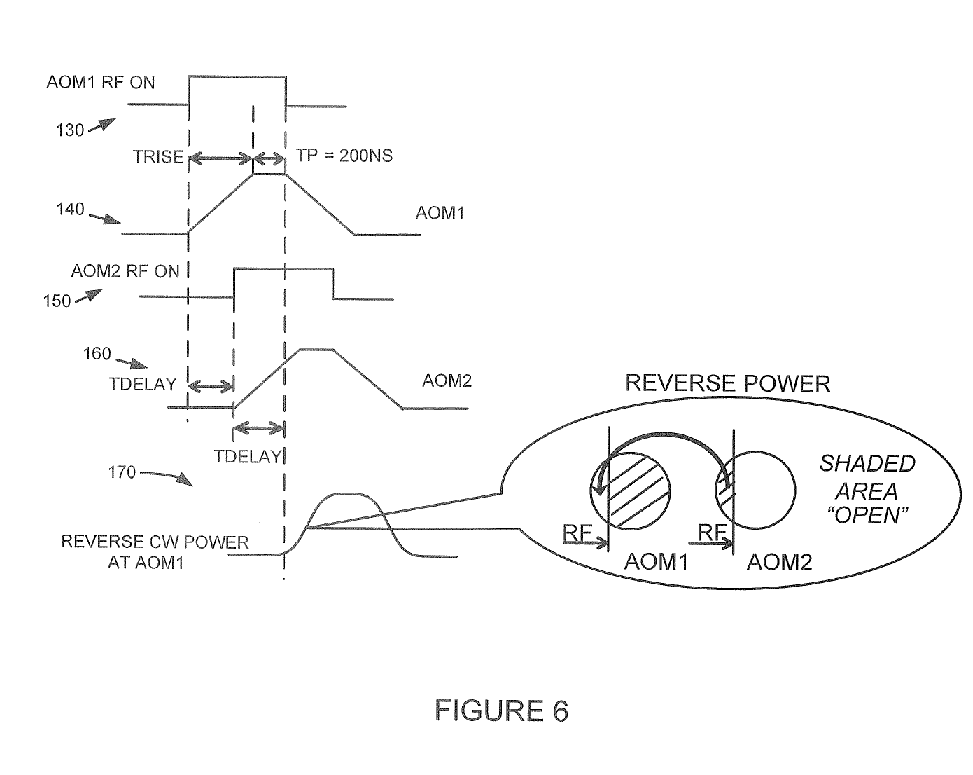

FIG. 6 is a timing diagram 600 depicting how reflected light is diverted by the isolation stage (e.g., isolation stages 66 and 76). The timing diagram 600 depicts one embodiment of a timing pattern that may be used. Based on the description provided below, those skilled in the art will be able to generate and implement alternate timing patterns to prevent reflected light from reaching a seed module.

As depicted in graphs 130 and 140, RF power is provided to the first AOM 106 and remains on for a time equal to the sum of the time required for the acoustic wave to cover the beam aperture 94 (labeled TRISE) and the optical pulse duration (labeled TP). After a time delay (labeled TDELAY), in graphs 150 and 160. RF power is provided to the second AOM 112 as described in connection with the first AOM 106.

The delay between the times labeled “TP” is the delay introduced by the delay device 11.0. The delay device 110 may, for example, provide a delay of at least 300 nanoseconds. The timing of the AOMs and the amount of delay introduced by the delay line vary according to the diameter of the beam, the direction of acoustic wave propagation within the AOM, and the presence of beam imaging. The delay can be calculated in a variety of ways for different implementations. The following example implementations are provided as a guide to illustrate how the necessary amount of delay can be determined.

The diameter of the beam affects amount of the time TRISE required for the acoustic wave to occlude the beam aperture 94. For a Gaussian beam with a size defined as 1/e², TRISE can be approximated as a time to traverse its width. As is apparent to those skilled in the art, for 2.7 millimeter beam, TRISE is 610 nanoseconds and for a 6.5 millimeter beam, TRISE is 1470 nanoseconds.

When the acoustic waves within the AOMs propagate in the same direction, as discussed in connection with FIG. 5, the minimum amount of delay that should be provided by the delay device positioned between the AOMs in the isolation stage can be calculated as:

TDELAY>TRISE+TP/2

where TDELAY is the delay provided by the delay device 110, TRISE is the the time required for the acoustic wave to occlude the beam aperture in the AOM, and TP is the optical pulse duration. The delay is at least the calculated times to allow the AOMs to open at different times, and the time difference between when the respective gates open is long enough to ensure that, in combination, the two AOMs are completely or substantially closed when reflected light arrives at the isolation stage. As will be apparent to those skilled in the art based on this disclosure, the upper limit of the time delay is bound by properties of the delay device 110, including, but not limited to, the length, volume, and loss of the delay device 110.

In instances where the respective acoustic waves in the AOMs are propagated in opposing directions, the AOMs are said to be cross-fired. The cross-firing of the AOMs is accomplished by initiating the acoustic wave at one end in the first AOM and at the opposite end in the second AOM. Because the acoustic waves travel in opposite directions when the AOMs are cross-fired, the minimum amount of delay provided by the delay device position between the AOMs in the isolation stage is shorter and can be calculated as:

TDELAY>(TRISE+TP)/2

In some instances, as depicted by diagram 170, beam imaging may be observed. As explained above, beam imaging can occur when the acoustic wave partially overlaps with the beam aperture on the AOM. As depicted in FIG. 6, the beam imaging phenomena can also be exploited to reduce the amount of delay introduced by the delay device such that a first portion of the reflected light is diverted at the second AOM 112 and the remaining portion of the light is diverted by the first AOM 106. Because the AOMs need only be partially closed to divert a portion of the reflected light, the delay introduced by the delay device 110 can be shortened according to the same equation used for cross-fired AOMs, described above.

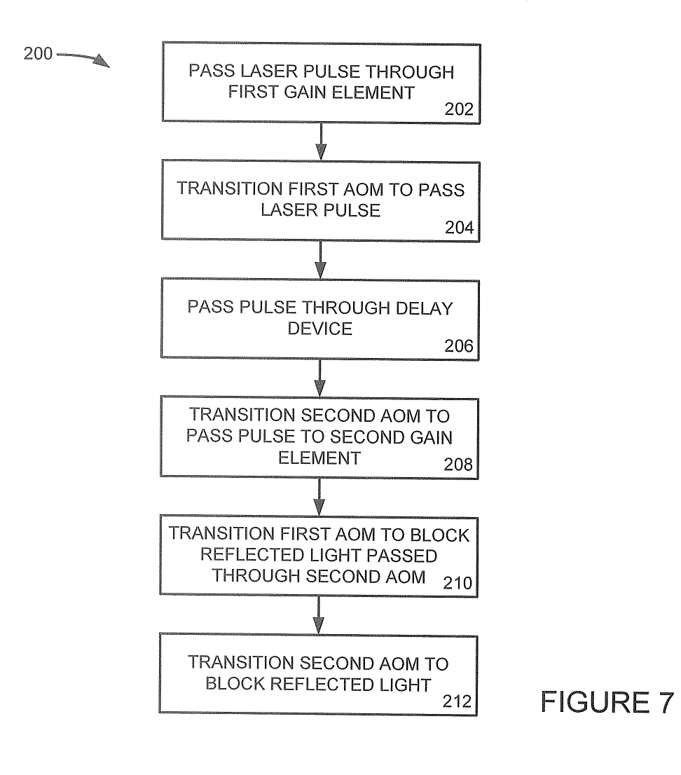

FIG. 7 is a flowchart of one embodiment of a method 200 of diverting reflected light using an isolation stage. The operations of the method 200 may be performed during overlapping points in time as described herein.

In an operation 202, the laser pulse is optionally passed through a first gain element. The first gain element may be a pre-amplifier, such as pre-amplifier 74 of FIG. 3.

Next, in an operation 204 a first AOM (such as first AOM 106 of FIG. 5) is transitioned to pass the laser pulse onto an optical path (e.g., optical path 104 in FIG. 5), As discussed above, the first AOM is transitioned by creating an acoustic wave that propagates across the AOM to overlap with a beam aperture (e.g., beam aperture 94 in FIG. 5).

Next, in an operation 206, the laser pulse is passed through a delay device (e.g., delay device 110 of FIG. 5). The delay device increases the amount of travel time between the first AOM and the second AOM in the isolation stage.

Next, in an operation 208, a second AOM (e.g., second AOM 112 of FIG. 5) is transitioned to pass the laser pulse onto the optical path (e.g., optical path 104) to an optional second gain element (e.g., pre-amplifier 84 of FIG. 3). The second AOM is similarly transitioned as the acoustic wave propagates past a beam aperture in the AOM.

Next, in an operation 210, the first AOM is transitioned to divert reflected light passed through the second AOM and the delay device. The first AOM is transitioned as the acoustic wave propagates past a beam aperture in the AOM. In practice, the operation 210 preferably occurs following operation 204 and overlaps with the operations 206 and 208.

Next, in an operation 212, the second AOM is transitioned to divert reflected light from further components in the LPP EUV system. In operation, the operation 212 preferably occurs following operation 208 and overlapping with the operation 210.

The isolation stage described herein allows a pulse to travel an optical path within a seed pulse generation system while preventing reflected light that is travelling in an opposite direction along the optical path from reaching sensitive and fragile components upstream of the isolation stage. The isolation stage introduces a delay between two AOMs within the system. The delay can be shortened by cross-firing the AOMs or when the phenomenon of beam imaging is observed.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used, and possibly different types of drive lasers and/or focus lenses.

Note that as used herein, the term “optical component” and its derivatives includes, but is not necessarily limited to, one or more components which reflect and/or transmit and/or operate on incident light and includes, but is not limited to, one or more lenses, windows, filters, wedges, prisms, grisms, gradings, transmission fibers, etalons, diffusers, homogenizers, detectors and other instrument components, apertures, axicons and mirrors including multi-layer mirrors, near-normal incidence mirrors, grazing incidence mirrors, specular reflectors, diffuse reflectors and combinations thereof. Moreover, unless otherwise specified, neither the terms “optic,” “optical component” nor their derivatives, as used herein, are meant to be limited to components which operate solely or to advantage within one or more specific wavelength range(s) such as at the EUV output light wavelength, the irradiation laser wavelength, a wavelength suitable for metrology or some other wavelength.

As noted herein, various variations are possible. A single seed laser may be used in some cases rather than the two seed lasers illustrated in the FIG. 2. A common isolation stage may protect two seed lasers, or either or both of the seed lasers may have their own isolation stages for protection. An isolation stage may be positioned elsewhere in the seed generation system 60, such as after the pre-amplifier 84. A single Bragg AOM may be used in some instances, or more than two Bragg AOMs may be used to protect a single seed laser if desired. Other types of AOMs may be used as well.

It should also be appreciated that the described method and apparatus can be implemented in numerous ways, including as a process, an apparatus, or a system. The methods described herein may be implemented by program instructions for instructing a processor to perform such methods, and such instructions recorded on a computer readable storage medium such as a hard disk drive, floppy disk, optical disc such as a compact disc (CD) or digital versatile disc (DVD), flash memory, etc., or via a computer network wherein the program instructions are sent over optical or electronic communication links. Such program instructions may be executed by means of a processor or controller, or may be incorporated into fixed logic elements. It should be noted that the order of the steps of the methods described herein may be altered and still be within the scope of the disclosure.

These and other variations upon the embodiments are intended to be covered by the present disclosure, which is limited only by the appended claims.

What is claimed is:

1. A system comprising:
a laser seed module for producing laser light on an optical path;
a first gain element positioned along the optical path;
a second gain element positioned along the optical path after the first gain element; and
an isolation stage positioned along the optical path between the first gain element and the second gain element, the isolation stage configured to divert light that has been reflected back along the optical path through the second gain element, the isolation stage comprising:
a first acoustic-optical modulator (AOM) configured to transition over a first period of time between a first state in which light is directed along the optical path and a second state in which light is not directed along the optical path;
a second AOM configured to transition over a second period of time between a first state in which light is directed along the optical path and a second state in which light is not directed along the optical path, the transition of the second AOM occurring at a time after the transition of the first AOM; and
a delay device positioned between the first AOM and the second AOM and configured to delay the transmission of light between the first AOM and the second AOM for a time determined based upon the first and second transition times of the AOMs such that any light reflected back along the optical path that passes through the second AOM will not pass through the first AOM and back to the laser seed module.

2. The system of claim 1, wherein the period of time to transition is further based upon a width of the laser beam.

3. The system of claim 1, wherein the delay is further based upon an occurrence of beam imaging.

4. The system of claim 3, wherein, if beam imaging occurs, the delay is further determined such that a first portion of the laser beam is diverted by the second AOM and a remaining portion of the laser beam is diverted by the first AOM.

5. The system of claim 1, further comprising one or more other elements positioned beyond the second gain element.

6. The system of claim 5, wherein the one or more other elements comprise an extreme ultraviolet (EUV) plasma chamber.

7. The system of claim 5, wherein the one or more other elements comprise a power amplifier.

8. The system of claim 1, wherein the first gain element and the second gain element comprise pre-amplifiers.

9. The system of claim 1, further comprising a second isolation stage positioned along the optical path beyond the second gain element.

10. The system of claim 1, further comprising a second isolation stage positioned along the optical path between the first gain element and the seed laser.

11. The system of claim 1, wherein the isolation stage is further configured to prevent self lasing in the first gain element by diverting reflected light.

12. The system of claim 1, wherein the first AOM and the second AOM are cross-fired.

13. The system of claim 12, wherein the delay is further determined based upon the width of the laser beam.

14. A method comprising:
producing laser light on an optical path;
passing a laser pulse generated from the laser light through a first gain element positioned along the optical path;
passing the laser pulse through an isolation stage positioned along the optical path after the first gain element, the isolation stage configured to divert light reflected back along the optical path from any elements located beyond the isolation stage, the isolation stage comprising:
a first acoustic-optical modulator (AOM) configured to transition over a first period of time between a first state in which light is directed along the optical path and a second state in which light is not directed along the optical path;
a second AOM configured to transition over a second period of time between a first state in which light is directed along the optical path and a second state in which light is not directed along the optical path, the transition of the second AOM occurring at a time after the transition of the first AOM; and
a delay device positioned between the first AOM and the second AOM and configured to delay the transmission of light between the first AOM and the second AOM for a time determined based upon the first and second transition times of the AOMs such that any light reflected back along the optical path that passes through the second AOM will not pass through the first AOM and back to the laser seed module; and
passing the laser pulse through a second gain element positioned along the optical path after the isolation stage.
